(19) United States
(12) Patent Application Publication
(10) Pub. No.: US 2026/0143326 A1
(43) Pub. Date: May 21, 2026

(54) AGGREGATING DATA FROM INTERNET OF THING DEVICES

(71) Applicant: Intrado Life & Safety, Inc., Longmont, CO (US)

(72) Inventors: Robert E. Leetun, Longmont, CO (US); John Lawrence Snapp, Everett, WA (US); Joshua S. Burch, Mead, CO (US); Patrick Arsenault, Montreal (CA); Sam R. Bauder, Berthoud, CO (US)

(21) Appl. No.: 19/447,595

(22) Filed: Jan. 13, 2026

Related U.S. Application Data
(63) Continuation of application No. 18/971,266, filed on Dec. 6, 2024.
(63) Continuation of application No. 18/742,905, filed on Jun. 13, 2024.

(51) Int. Cl. H04W 4/90; H04L 67/12; H04M 11/04

(52) U.S. Cl. CPC H04W 4/90; H04L 67/12; H04M 11/04

(57) ABSTRACT

Particular example embodiments described herein can provide for a system, an apparatus, and a method for determining an emergency event is occurring, identifying one or more IoT devices in an area of the emergency event, notifying an emergency service personnel of the one or more IoT devices in the area of the emergency event, allowing the emergency service personnel to access at least one of the one or more IoT devices, and communicating real-time data from the at least one of the one or more IoT devices to the emergency service personnel.

### CROSS-REFERENCE TO RELATED APPLICATIONS

This disclosure is a Continuation of Utility patent application Ser. No. 18/742,905, entitled “SAFETY NETWORK OF THINGS“filed in the United States Patent Office on Jun. 13, 2024, which is hereby incorporated by reference in its entirety, and thereby claims all benefits and priority to which it is entitled including any and all provisions of the CFR, including at least 37 CFR 1.53 and is a Continuation of Utility patent application Ser. No. 18/971,266 entitled “AGGREGATING DATA FROM INTERNET OF THING DEVICES TO HELP DETECT EMERGENCY EVENT” filed in the United States Patent Office on Dec. 6, 2024, which is hereby incorporated by reference in its entirety, and thereby claims all benefits and priority to which it is entitled including any and all provisions of the CFR, including at least 37 CFR 1.53.

### TECHNICAL FIELD

This disclosure relates in general to the field of computing and/or networking and, more particularly, to a system, an apparatus, and a method to enable aggregating data from Internet of Things (IoT) devices.

### BACKGROUND

Internet of things (IoT) devices are self-reporting devices that can connect to other devices and systems over a network (e.g., Internet) to exchange data. IoT devices are programmed for specific applications and can be embedded into other devices, such as appliances, gadgets, machines, or sensors. IoT devices have at least one sensor or actuator to interact with the physical world and at least one network interface, such as Bluetooth, Wi-Fi, or Ethernet, to connect with the digital world. IoT devices are not limited to computers or machinery and can include anything with a sensor that is assigned a unique identifier (UID).

Consumer IoT devices include personal and wearable devices and are often referred to as smart devices. Industrial IoT devices include a system of interconnected devices in the industrial sector, including manufacturing machinery and devices used for energy management. Vehicle IoT devices, or Automotive IoT devices, include sensors, cameras, GPS trackers, telematics, etc. and are installed into vehicles to gather real-time data related to the vehicle where the IoT device is located. Commercial IoT devices include tools and systems used outside of a home. Businesses and health care organizations leverage commercial IoT for auditable data trails and consumer management.

Some IoT devices have the capability to communicate information to a public-safety answering point (PSAP) or PSAP related device. A public-safety answering point (PSAP), sometimes called a public-safety access point or an emergency communication center, is a call center where emergency/non-emergency calls (like police, fire brigade, ambulance) are received and handled. The PSAP is a call center in almost all the countries, including Canada and the United States, where a trained PSAP operator or emergency service personnel is typically responsible for answering calls to an emergency telephone number for police, firefighting, and ambulance services.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a system to help enable aggregating data from Internet of Things (IoT) devices, in accordance with an embodiment of the present disclosure;

FIG. 2 is a simplified block diagram of a particular implementation of a system to help enable aggregating data from IoT devices, in accordance with an embodiment of the present disclosure;

FIG. 3 is a simplified block diagram of a particular implementation of a system to help enable aggregating data from IoT devices, in accordance with an embodiment of the present disclosure;

FIG. 4 is a simplified block diagram of a particular implementation of a system to help enable aggregating data from IoT devices, in accordance with an embodiment of the present disclosure;

FIG. 5 is a simplified block diagram of a particular implementation of a system to help enable aggregating data from IoT devices, in accordance with an embodiment of the present disclosure;

FIG. 6 is a simplified block diagram of a particular implementation of an emergency detection engine to help enable aggregating data from IoT devices, in accordance with an embodiment of the present disclosure;

FIG. 7 is simplified block diagram illustrating example details of a particular implementation of a system to help enable aggregating data from IoT devices, in accordance with an embodiment of the present disclosure;

FIG. 8 is simplified block diagram illustrating example details of a particular implementation of a system to help enable aggregating data from IoT devices, in accordance with an embodiment of the present disclosure;

FIG. 9 is a simplified flowchart illustrating potential operations to help enable obtaining details related to a public safety answering point, in accordance with an embodiment of the present disclosure;

FIG. 10 is a simplified flowchart illustrating potential operations to help enable aggregating data from IoT devices, in accordance with an embodiment of the present disclosure;

FIG. 11 is a simplified flowchart illustrating potential operations to help enable aggregating data from IoT devices, in accordance with an embodiment of the present disclosure;

FIG. 12 is a simplified block diagram illustrating example details of an example computer model inference and computer model training to help enable aggregating data from IoT devices, in accordance with an embodiment of the present disclosure; and

FIG. 13 is a simplified block diagram illustrating examples details of an example neural network architecture to enable aggregating data from IoT devices, in accordance with an embodiment of the present disclosure.

The FIGURES of the drawings are not necessarily drawn to scale, as their dimensions can be varied without departing from the scope of the present disclosure.

### DETAILED DESCRIPTION

The following detailed description sets forth examples of apparatuses, methods, and systems relating to aggregating data from Internet of Things (IoT) devices, in accordance with an embodiment of the present disclosure. Features such as structure(s), function(s), and/or characteristic(s), for example, are described with reference to one embodiment as a matter of convenience; various embodiments may be implemented with any suitable one or more of the described features.

### Overview

Internet of things (IoT) devices are self-reporting devices that can connect to other devices and systems over a network (e.g., Internet) to exchange data. Data from one or more IoT devices can be communicated to an emergency detection engine and the emergency detection engine can use the data to detect an emergency event or a potential emergency event. When an emergency event or a potential emergency event is detected, the emergency detection engine can communicate data from the one or more IoT devices that is relevant to the detected emergency event or potential emergency event to a public safety answering point (PSAP) where an operator at the PSAP can dispatch emergency services to the emergency event or potential emergency event. In some examples, the emergency detection engine uses a computer model or machine learning to identify the emergency event or potential emergency event and to determine the data from the one or more IoT devices that is relevant to the detected emergency event or potential emergency.

Using the emergency detection engine to use data from the one or more IoT devices to identify the emergency event or potential emergency event can reduce response times beyond a simple voice call to 911 and can provide for a more accurate response by the PSAP, ultimately resulting in better outcomes for those in an emergency situation. For example, the data from the one or more IoT devices can include detailed crash information from vehicle IoT devices, video or pictures from video or camera IoT devices, alarm data from security IoT devices, and other data from IoT devices including fire and/or smoke detection, gunshot detection, medical data, and other types of data from IoT devices. Using a computer model or machine learning, the data from the one or more IoT devices can be analyzed by the emergency detection engine to identify the emergency event or potential emergency event. In addition, the data from the one or more IoT devices can be filtered and data relevant to the emergency event or potential emergency event can be communicated to a PSAP operator to allow the PSAP operator to review the relevant data and dispatch emergency services to the emergency event or potential emergency event.

In an illustrative example, a vehicle accident can occur. The emergency detection engine can receive data from one or more vehicle IoT devices and determine the severity of the vehicle accident (e.g., a very low speed single vehicle accident, a minor two car accident such as a low-speed rear end collision, a high-speed multiple vehicle accident, etc.). In addition, if a video or camera IoT device is available, the data from the video or camera IoT device can be used by the emergency detection engine to determine if the vehicle accident is an emergency event or potential emergency event (e.g., a vehicle is overturned and on fire or smoking, a light pole was damaged or knocked over and live electrical wires are on the ground and creating a safety hazard). In some examples, IoT devices in buildings near the vehicle accident can be used by the emergency detection engine to determine if there is any collateral damage from the vehicle accident (e.g., a vehicle hit a light pole and the light pole was damaged or knocked over and created a fire in a nearby building). If an emergency event or a potential emergency event is detected, the emergency detection engine can communicate data from the one or more IoT devices that is relevant to the detected emergency event or potential emergency event to the PSAP where the PSAP operator can use the relevant data to dispatch emergency services to the emergency event or potential emergency event. For example, the relevant data can include whether or not a vehicle has been flipped over, whether or not one or more passengers are stuck inside a vehicle, a video of the vehicle accident to provide the PSAP operator with a visual of the vehicle accident, any alarms that have been triggered in surrounding buildings, etc.

In a specific example, a gunman takes a firearm out of their vehicle in a school or building parking lot and begins walking toward a building. Using a computer model or machine learning, the emergency detection engine can be trained to detect firearms and can detect the firearm. The detection of the firearm can be sent to a PSAP where the PSAP operator can verify the firearm detection and initiate an emergency response by police. By using data from one or more IoT devices, the emergency detection engine can detect an emergency event or a potential emergency event quicker than a human can identify the situation and dial 911 to report the emergency event or a potential emergency event. Also, because the emergency detection engine filters the data from the one or more IoT devices and sends the relevant data to the PSAP, the PSAP operator is not having to sort through irrelevant data and can relatively quickly review the relevant data to dispatch emergency services to the emergency event or potential emergency event.

### Example Systems, Apparatuses, and Methods

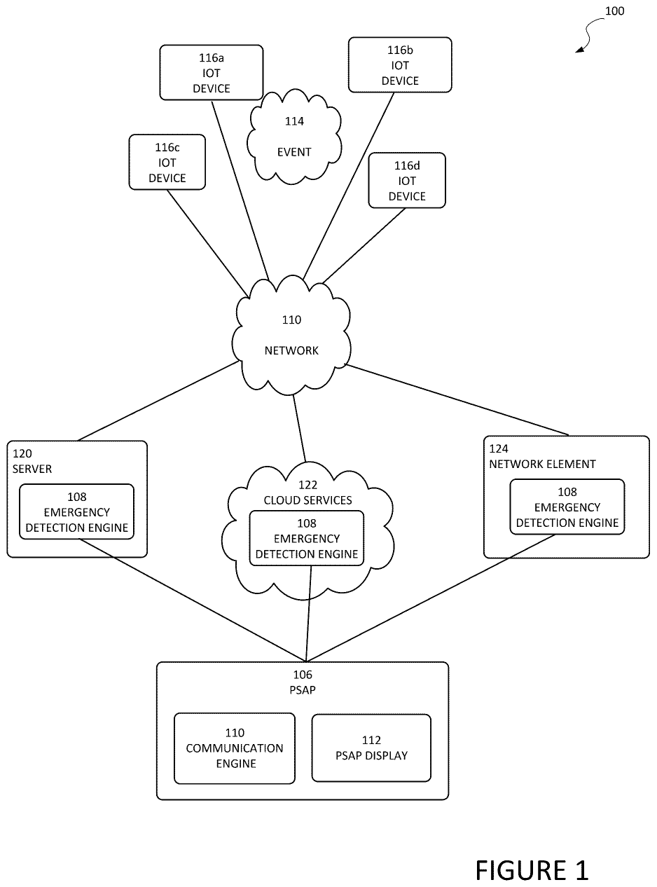

FIG. 1A is simplified block diagram of a particular non-limiting system 100 to enable aggregating data from Internet of Things (IoT) devices to help detect an emergency event or a potential emergency event. The system 100 can include an emergency detection engine 108 and a PSAP 106. The emergency detection engine 108 can be located in a server 120, cloud services 122, and/or a network element 124. In some examples, the emergency detection engine 108 can include a computer model or machine learning to help detect an emergency event or a potential emergency event and/or determine the IoT data that is relevant to the emergency event or the potential emergency event. The PSAP 106 can include a communication engine 110 and a PSAP display 112.

In an illustrative example, an event 114 can occur and be detected by one or more IoT devices 116. The event 114 can be an event that may be an emergency event where emergency services are routed to the event 104 or an event where a PSAP operator may monitor the event 104 to determine if emergency services need to be routed to the event. For example, the emergency event may be a fire, a vehicle accident, shooting, earthquake, loud noise, noxious smell, etc.

When the event 114 is detected by the one or more IoT devices 116, for example, by the IoT device 116a, a notification of the event 114 is communicated to the emergency detection engine 108. The notifications from the one or more IoT devices 116 are analyzed by the emergency detection engine 108 to determine if the event 114 is an emergency event or a potential emergency event that requires attention from the PSAP 106. For example, the event 114 may be a multiple vehicle accident where airbags were deployed, a fire, a gunshot, or some other event that is likely to be an emergency event and require a PSAP operator to dispatch emergency services to the location of the event 114. If the event is an emergency event, the emergency detection engine 108 can communicate the notification from the one or more IoT devices 116 to the PSAP 106 where details related to the event 114 are displayed on the PSAP display 112 to allow the PSAP operator to take the appropriate action (e.g., dispatch police and ambulance services if the event 114 is a multiple vehicle crash where airbags were deployed, dispatch the fire département if the event 114 is a fire, etc.). The PSAP display 112 can include a representation of IoT devices available in the area where the event 114 occurred and the PSAP operator can select one or more specific IoT devices available in the area where the event 114 occurred and view data from the selected one or more specific IoT devices.

In some examples, the event 114 may be an event that is not an emergency event or may be an event that could become an emergency event. For example, data from a single IoT device 116 may indicate the event 114 is a low-speed single vehicle crash where airbags are not deployed, a smoke detector that detected overcooked food, or some other event that is not an emergency event. If data from a single IoT device 116 suggests the event is not an emergency event, the emergency detection engine 108 will not communicate the notification from the IoT device 116 to the PSAP 106. Instead, the emergency detection engine 108 may analyze and correlate notifications from other IoT devices 116 to determine if the event 114 is an emergency event or may become an emergency event.

In a specific example, the IoT device 116a may a smoke detector in a kitchen, the IoT device 116b may be an oven sensor to detect the temperature of an oven, the IoT device 116c may be a thermostat that can detect the temperature of the room when the IoT device 116c is located, and the IoT device 116d may be a carbon monoxide detector. If the IoT device 116a (a smoke detector in a kitchen) is the IoT device that communicated the notification, kitchen smoke detectors are known to send false alarms due to overcooked food. The emergency detection engine 108 can analyze and correlate notifications from IoT devices 116b-106d to determine if the event 114 is an emergency event. For example, if the oven temperature reading from IoT device 116b is high enough to indicate a possible fire, the room temperate reading from the IoT device 116c indicates the temperature is rising rapidly, and/or the carbon monoxide levels detected by the IoT device 116d are above normal levels, the emergency detection engine 108 can determine that the event 114 is an emergency event and the emergency detection engine 108 can communicate the notification from the IoT device 106a and IoT devices 116b, 106c, and/or 106d to the PSAP 106 where details related to the event 114 are displayed on the PSAP display 112 to allow the PSAP operator to take the appropriate action (e.g., dispatch the fire département).

In some examples, if the event is an emergency event and other IoT devices 116 are available, notifications and relevant data from the one or more IoT devices 116 may be sent to the PSAP. For example, if the IoT 116a device is an IoT device in a vehicle and detected a vehicle crash where the airbags were deployed, the notification from the IoT device 116a would be considered as being related to an emergency event and the emergency detection engine 108 would communicate the notification from the IoT device 106a to the PSAP 106. Also, if the IoT device 116b is a street camera, the emergency detection engine 108 may attempt to access the IoT device 116b to obtain a video of the emergency event and communicate the video feed from the IoT device 116b to the PSAP 106.

It is to be understood that other embodiments and implementations may be utilized, and structural changes may be made without departing from the scope of the present disclosure. Substantial flexibility is provided by the system and method in that any suitable arrangements and configuration may be provided without departing from the teachings of the present disclosure. For purposes of illustrating certain example techniques to enable aggregating data from IoT devices, the following foundational information may be viewed as a basis from which the present disclosure may be properly explained. A number of prominent technological trends are currently afoot (e.g., more mobile computing devices, more mobile services, more Internet traffic), and these trends are changing the media delivery landscape. One trend is IoT devices.

IoT devices are devices that can connect to other devices and systems over the Internet to exchange data. IoT devices can include consumer IoT devices, industrial IoT devices, vehicle IoT devices, commercial IoT devices, and other IoT devices. The growing wave of IoT devices, from smartphones to home security systems, has created an influx of data that could help first responders save lives. For example, IoT devices can track mobile locations in real-time, smart thermometers can detect temperature changes during fires, security systems can simultaneously detect movement and share real-time or live video feeds, IoT devices in vehicles can detect conditions before, during, and after a vehicle accident. These real-time data streams can make a huge impact on an emergency response system, but most PSAPs lacks the technology to access this information securely and efficiently. Also, if all the data from IoT devices were sent to a PSAP, the data stream could easily overwhelm a PSAP operator and the PSAP operator may have difficulty determining the data from the IoT devises that is relevant to an emergency event.

A PSAP, sometimes called a public-safety access point, is a call center where emergency/non-emergency calls (like police, fire brigade, ambulance) are received. When a communication is sent to a PSAP, a highly trained professional human PSAP operator is expected to respond to the communication. However, PSAP operators are part of an industry under immense pressure because of understaffing and a host of other issues. PSAP centers are struggling with surging call and text volumes, complex compounded emergencies, outdated technologies, and insufficient support.

PSAP call-takers frequently receive incomplete or inaccurate descriptions of an event from callers who are confused, in distress, or unable to verbally communicate. Today's 911 infrastructure was designed for landline based communication. When a PSAP operator answers an emergency call, they are tasked with acquiring as much information as possible from the caller, including the location and nature of the event. Often, callers can be panicked, injured or otherwise unable to reliably articulate the information the PSAP operator needs to dispatch the appropriate type and amount of first responders to the event and/or provide the dispatched first responders with an accurate description of the event. In addition, acquiring the information takes time and during an emergency event, every second counts. The real-time data streams from IoT devices can make a huge impact on the emergency response system, especially with the amount of information available from IoT devices as well as with the speed the information can be delivered to a PSAP operator. What is needed is a way to deliver the relevant data from IoT devices to the PSAP operator and help enable aggregating data from IoT devices.

A system, method, apparatus, means, etc. to help enable aggregating data from IoT devices can help resolve these issues (and others). In an example, a system and method can include an emergency detection engine (e.g., the emergency detection engine 108). The emergency detection engine can receive communications from one or more IoT devices and can use the data from the one or more IoT devices to help detect an emergency event or a potential emergency event. In addition, the emergency detection engine can determine what data from the one or more IoT devices is relevant to the emergency event or the potential emergency event and communication the relevant data to the PSAP. In some examples, the emergency detection engine uses a computer model or machine learning to detect an emergency event or a potential emergency event and/or determine what data is relevant to the emergency event or the potential emergency event.

PSAPs want additional data relevant to an event to help determine if the event is an emergency event and what type of emergency response is needed. PSAP hardware and software vary by country, state, region, county, city, and even sometimes by response jurisdictions within a city. To make matters more confusing, often there is overlap in jurisdictions. This means that every PSAP for the most part (over 6,000 across North America) may have different hardware and software combinations, and even different versions based on a specific PSAP's protocols, policies, and procedures. In addition, network security and internet access varies greatly from one PSAP to the next. It is for this reason that PSAPs want to receive additional information about an emergency call via their existing systems within existing workflows and call queues. There is also a quickly growing trend to receive fewer voice calls and more requests for assistance via other means such as data messages to 911, text messages to 911, or direct integration into a computer-aided dispatch system. Integrating the data from IoT devices into the 911 communication workflow is beneficial for public safety and can help PSAP operators detect an emergency event or a potential emergency event and the type of response needed for the emergency event or potential emergency event. In some examples, when an event occurs, the PSAP display 112 can include a representation of IoT devices available in the area where the event 114 occurred and the PSAP operator can select one or more specific IoT devices available in the area where the event 114 occurred and view data from the selected one or more specific IoT devices.

In an illustrative example of a vehicle accident, sensors in the vehicles are capable of communicating the location of a vehicle, whether or not the vehicle is overturned or on fire, how many occupants are in the vehicle, the speed upon impact, how many airbags were deployed and which ones, along with other data. Delivering this information to a PSAP can make the difference in how quickly an emergency event can be identified and the type and number of responders that are dispatched to the emergency event. For example, if there was a vehicle accident where the vehicle has rolled over, caught fire, and the doors of the vehicle will not open, the Jaws of Life may be needed immediately. Several valuable minutes may be lost while waiting for an on-scene decision as the first responders arrive, assess the situation and call for the Jaws of Life. With information from one or more IoT devices available to the PSAP operator, the PSAP operator can determine the severity of the accident, that an occupant of the vehicle is trapped, and the PSAP operator can dispatch the Jaws of Life when dispatching the first responders.

Integrating IoT devices offer opportunities to improve PSAP capabilities. For examples, one or more IoT devices across a city may detect a major incident and critical data can be relayed to the nearest PSAP, ensuring quick and informed response efforts. PSAP operators can take information feeds from the IoT devices (e.g., cameras, carbon monoxide detectors, heat sensors, fire alarms) that can source near real-time data feeds to help the PSAP operator make rapid decisions on the type of response needed for a specific emergency event. This data can be aggregated, analyzed and turned into actionable information such as situational reports, then pushed out to first responders in route to support decision-making and help mitigate risk. In addition, further data intelligence could be gathered by IoT devices such as cameras on responders who are at the scene, which can provide commanders with an enhanced, near real-time view, as well as a useful data source for post-incident reports. In some examples, public warning systems are yet another set of helpful IoT public safety use cases that aid in both broadcasting and response to large-scale incidents, such as a natural disaster where it is vital the public is alerted as soon as possible. IoT sensors can provide an early warning system via link-ups with public displays, billboards, connected vehicles and smartphones. For example, as a hurricane approaches, data gathered from IoT devices and sensors can be collected and analyzed by the emergency detection engine to help with evacuation efforts.

In a specific example, industrial IoT devices include a framework of intelligent IoT devices enriched with inbuilt computing capabilities and connected to industry-level data monitoring and collection systems to perform analytics and monitoring within an industrial ecosystem. In a specific illustrative example, IoT devices in an oilfield provide a powerful platform for measuring and controlling key production parameters like oil and gas flow rates, line and wellhead pressure, status of pump operation, and monitoring of tank levels. Modern remote terminal units automate oil and gas production processes by performing many complex calculation tasks faster, holding larger local databases, and controlling remote sites without active intervention from the control center. The industrial IoT devices can monitor motor winding temperatures, pressure monitoring, flow monitoring, temperature monitoring, leak detection, vibration monitoring, among other things. The emergency detection engine can be configured to achieve enhance system monitoring and control of oil spills, leakages, fire detection, and emergency shutdown. For example, should a sensor detect a leak of carbon monoxide, gas pipes could be automatically cut off.

By using data from one or more IoT devices, the emergency detection engine can detect an emergency event or a potential emergency event quicker than a human can identify the situation and report the emergency event or a potential emergency event. Also, because the emergency detection engine filters the data from the one or more IoT devices and sends the relevant data to a safety office and/or the PSAP, safety office and/or the PSAP operator is not having to sort through irrelevant data and can relatively quickly review the relevant data to dispatch emergency services to the emergency event or potential emergency event.

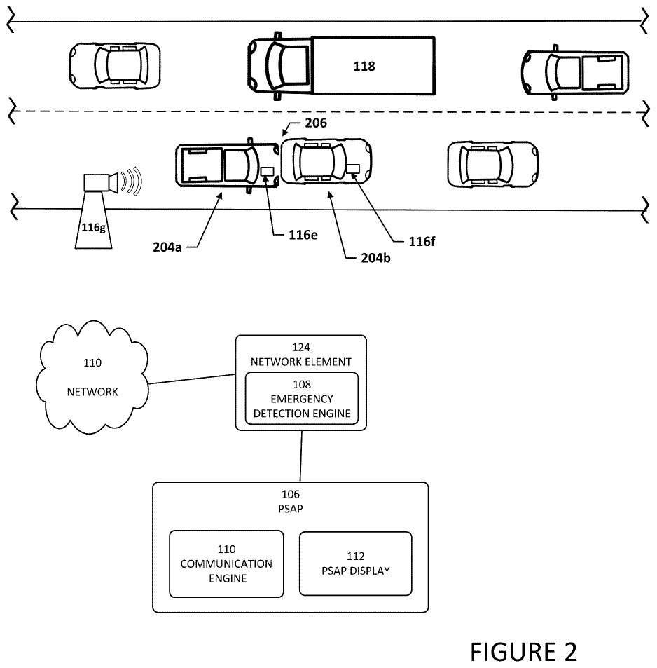

Turning to FIG. 2, FIG. 2 is a simplified block diagram illustrating example details of a particular non-limiting illustrative example of aggregating data from IoT devices. As illustrated in FIG. 2, vehicle 204a has struck vehicle 204b resulting in a vehicle accident event 206. IoT device 116e is located in the vehicle 204a and can detect conditions related to the vehicle 204a before, during, and after the vehicle accident event 206 and IoT device 116f is located in the vehicle 204b and can detect conditions related to the vehicle 204b before, during, and after the vehicle accident event 206.

The IoT device 116e can communicate with the emergency detection engine 108 and send data related to the conditions related to the vehicle 204a before, during, and after the vehicle accident event 206. In addition, the IoT device 116f can communicate with the emergency detection engine 108 and send data related to the conditions related to the vehicle 204b before, during, and after the vehicle accident event 206. The emergency detection engine 108 can use the data from the IoT device 116e and 116f and determine if the vehicle accident event 206 is an emergency event that requires attention from the PSAP 106. If the emergency detection engine 108 determines the vehicle accident event 206 is an emergency event that requires attention from the PSAP 106, the emergency detection engine 108 can communicate relevant details related to the vehicle accident event 206 to the PSAP 106 and the details can be displayed on the PSAP display 112 for the PSAP operator to use to determine the needed response.

In some examples, the emergency detection engine 108 can determine if any other IoT devices 116 are in the area of the vehicle accident event 206 to help the emergency detection engine 108 collect more details about the vehicle accident. For example, the emergency detection engine 108 may determine that the IoT device 116g, a street camera, is available. In some examples, the emergency detection engine 108 can use data from the IoT device 116g to help determine if the vehicle accident event 206 is an emergency event that requires attention from the PSAP 106. In some examples, the emergency detection engine 108 can communicate the video feed from the IoT device 116g to the PSAP 106 to allow the human operator to have a live view of the vehicle accident event 206 to help the PSAP operator determine the needed response to the vehicle accident event 206.

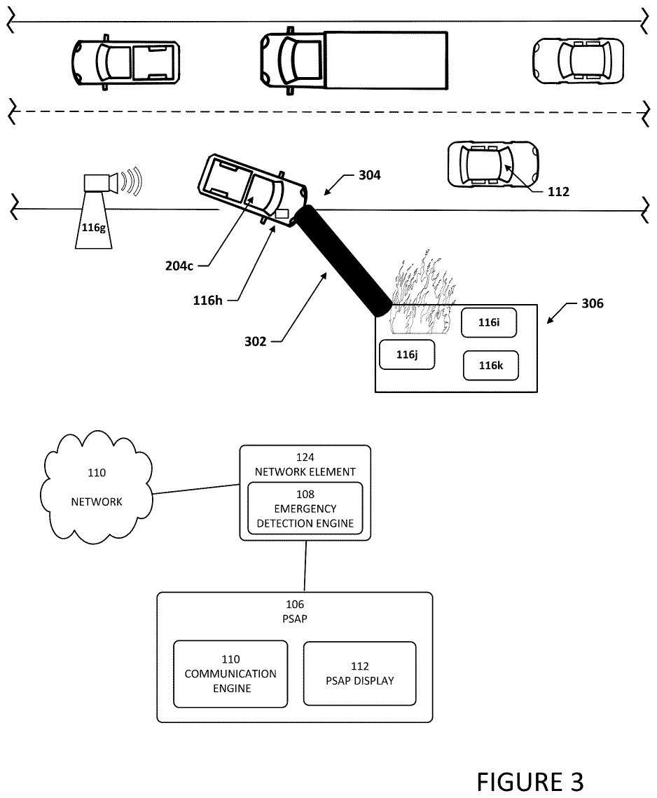

Turning to FIG. 3, FIG. 3 is a simplified block diagram illustrating example details of a particular non-limiting illustrative example of aggregating data from IoT devices. As illustrated in FIG. 3, vehicle 204c has been in a single vehicle accident event 304 and struck a light pole 302. In an illustrative example, IoT device 116h is located in the vehicle 204c and can detect conditions related to the vehicle 204c before, during, and after the single vehicle accident event 304.

The IoT device 116h can communicate with the emergency detection engine 108 and send data related to the conditions related to the vehicle 204c before, during, and after the single vehicle accident event 304. The emergency detection engine 108 can use the data from the IoT device 116h and determine if the single vehicle accident event 304 is an emergency event that requires attention from the PSAP 106. If the emergency detection engine 108 determines the single vehicle accident event 304 is an emergency event that requires attention from the PSAP 106, the emergency detection engine 108 can communicate relevant details related to the single vehicle accident event 304 to the PSAP 106 and the details can be displayed on the PSAP display 112 for the PSAP operator to use to determine the needed response.

In some examples, the emergency detection engine 108 can determine if any other IoT devices 116 are in the area of the single vehicle accident event 304 to help the emergency detection engine 108 collect more details about the vehicle accident. For example, the emergency detection engine 108 may determine that the IoT device 116g, a street camera, is available. In some examples, the emergency detection engine 108 can use data from the IoT device 116g to help determine if the single vehicle accident event 304 is an emergency event that requires attention from the PSAP 106. In some examples, the emergency detection engine 108 can communicate the video feed from the IoT device 116g to the PSAP 106 to allow the human operator to have a live view of the single vehicle accident event 304 to help the PSAP operator to use to determine the needed response.

With the live view of the single vehicle accident event 304, the emergency detection engine 108 may use a computer model or machine learning to identify that the light pole 302 has struck a building 306. Using the computer model or machine learning, the emergency detection engine 108 can use IoT devices 116 associated with the building 306 and determine if emergency services need to be deployed to the building 306. More specifically, the emergency detection engine 108 can use data from one or more of IoT device 116i (a smoke detector), IoT device 116j (a thermostat or room temperature gauge), and IoT device 116k (a security camera). One or more of the IoT devices 116i-116k may provide data that indicates the light pole 302 has cause a fire to start in the building 306. The emergency detection engine 108 can communicate the smoke detector data from the IoT device 116k, the room temperature data from the IoT device 116j, and/or the video feed from the IoT device 116k to the PSAP 106 to allow the human operator to dispatch an appropriate fire response team to the building 306. Without the additional data from the IoT devices 116i-116k, the PSAP operator and first responders would have been unaware of the fire until the first responders arrived on the scene of the single vehicle accident event 304. By using the data from the IoT devices 116i-116k to provide an early detection of the fire, precious time can be saved and an appropriate response to the single vehicle accident event 304 can be quickly dispatched.

In another illustrative example, the emergency detection engine 108 can receive data from IoT devices 116h-116k and aggregate the data to help detect the single vehicle accident event 304. The data relevant to the single vehicle accident event 304 can be communicated to the PSAP 106 to allow the human operator to determine the needed response. For example, the emergency detection engine 108 can send the relevant vehicle data from IoT device 116h to the PSAP, the video feed from IoT device 116g, the smoke detector data from the IoT device 116k, the room temperature data from the IoT device 116j, and/or the video feed from the IoT device 116k to the PSAP 106 to allow the human operator to dispatch an appropriate response team.

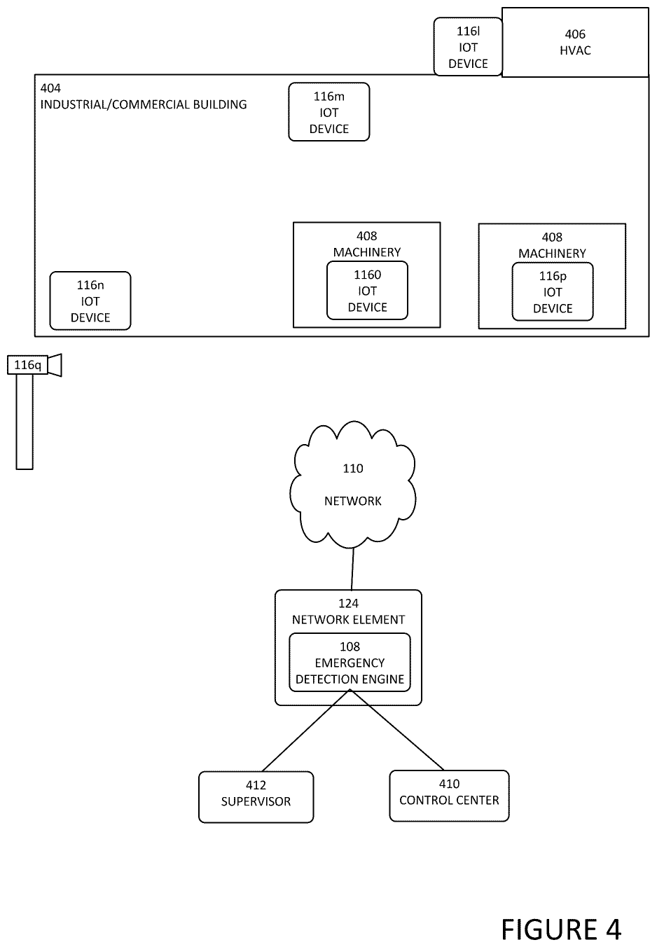

Turning to FIG. 4, FIG. 4 is a simplified block diagram illustrating example details of a particular non-limiting illustrative example of aggregating data from IoT devices. As illustrated in FIG. 4, an industrial/commercial building 404 can include one or more IoT devices 116. More specifically, IoT device 116l may be associated with an HVAC system 406, IoT device 116m may be associated with a fire detection system, IoT device 116n may be associated with building entry security, IoT devices 116o and 116p may be associated with one or more machinery 408 located in or around the industrial/commercial building 404, and IoT device 116q may be associated with a security camera. Data from each of the IoT devices 116l-116q can be communicated to the emergency detection engine 108.

The emergency detection engine 108 can aggregate the data from IoT devices 116l-116q to help detect an emergency event or a potential emergency event. In some examples, the emergency detection engine 108 can use a computer model of machine learning to collect and filter the data from each of the IoT devices 116l-116q to help detect an emergency event or a potential emergency event. For example, IoT device 116l (associated with the HVAC system 406) and IoT device 116m (associated with fire detection system) may detect early warning signs of a potential fire hazard. In another example, IoT device 116n (associated with building entry security) and IoT device 116q (associated with a security camera) may detect early warning signs of a potential break in. In yet another example, IoT devices 116o and 116p (associated with one or more machinery 408) may provide the emergency detection engine 108 with early detection of machinery failure.

The emergency detection engine 108 can collect data from IoT devices 116l-116q and communicate relevant data to a main control 410. In the case of a detected emergency situation, the emergency detection engine 108 can communicate an alert to the main control 410 along with the data from the IoT devices 116l-116q that is relevant to the emergency situation. In some examples, the emergency detection engine 108 can also communicate with a supervisor 412 (e.g., safety officer, building manager, etc.) to alert the supervisor 412 about the emergency situation.

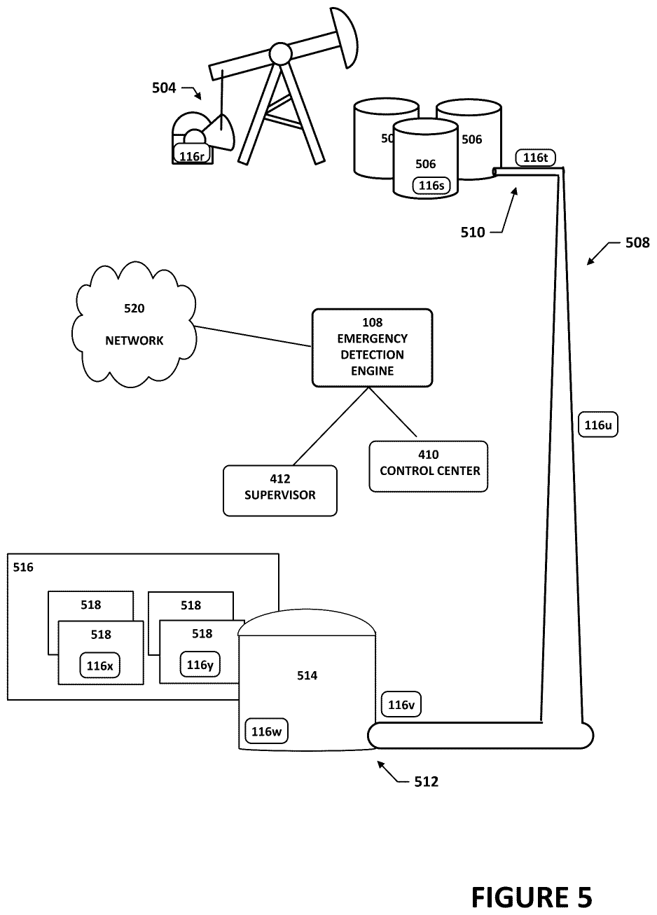

Turning to FIG. 5, FIG. 5 is a simplified block diagram illustrating example details of a particular non-limiting illustrative example of aggregating data from IoT devices. As illustrated in FIG. 5, a remote industrial equipment 504 can include an IoT device 116r, remote storage equipment 506 can include an IoT device 116s, a pipeline 508 can include an IoT device 116t, an inlet 510 to the pipeline 508 can include an IoT device 116u, and an outlet 512 of the pipeline 508 can include IoT device 116v. The outlet 512 of the pipeline 508 can be coupled to one or more storage tanks 514 and the one or more storage tanks 514 can include an IoT device 116w. The one or more storage tanks 514 can be coupled to a processing facility 516. The processing facility 516 can include processing equipment 518 and the processing equipment 518 can include IoT device 116x and IoT device 116y. Note that each of the remote industrial equipment 504, the remote storage equipment 506, the pipeline 508, the inlet 510 to the pipeline 508, the outlet 512 of the pipeline 508, the one or more storage tanks 514, the processing facility 516, and the processing equipment 518 can include one or more IoT devices 116 or may not include an IoT device 116.

Each of the IoT devices 116r-116y can be in communication with the emergency detection engine 108 using network 520. Network 520 can be a closed network or an open network. The emergency detection engine 108 can use a computer model or machine learning to collect and filter the data from each of IoT devices 116r-116y to detect an emergency event or a potential emergency event. In the case of a detected emergency event or a potential emergency event, the emergency detection engine 108 can communicate an alert to the main control 410 along with the data from the IoT devices 116r-116y that is relevant to the emergency situation. In some examples, the emergency detection engine 108 can also communicate with a supervisor 412 (e.g., safety officer, building manager, etc.) to alert the supervisor 412 about the emergency event or the potential emergency event.

In an illustrative example, the remote industrial equipment 504, the remote storage equipment 506, the inlet 510 to the pipeline 508, or the pipeline 508 may have an issue, malfunction, or some other condition that may be an emergency event or a potential emergency event. However, due to the remote location of the remote industrial equipment 504, the remote storage equipment 506, the inlet 510 to the pipeline 508, and the pipeline 508 the issue, malfunction, or some other condition may go unnoticed by human operators. The issue, malfunction, or some other condition can be reported to the emergency detection engine 108 by the IoT device 116 that detected the issue, malfunction, or some other condition. In some examples, the issue, malfunction, or some other condition by itself may not be enough to alert a human operator of an emergency event or a potential emergency event. However, using a computer model or machine learning, the emergency detection engine 108 is able to determine if the issue, malfunction, or some other condition is indicative of an emergency event or a potential emergency event. In some examples, data from IoT devices 116 other than the IoT device that reported the issue, malfunction, or other condition can be used to help the emergency detection engine 108 determine if the issue, malfunction, or some other condition is indicative of an emergency event or a potential emergency event. More specifically, the IoT device 116t may detect a low flow rate that is still within specification and the low flow rate (still within specification) by itself may not be enough to alert a human operator of an emergency event or a potential emergency event. Also, the IoT device 116r may detect a condition of the remote industrial equipment 504 that is within specification, however, when the low flow rate detected by the IoT device 116t is combined with data from the IoT device 116r, the emergency detection engine 108 may be able to determine the low flow rate and the condition of the remote industrial equipment 504 that is within specification is indicative of an emergency event or a potential emergency event. The emergency detection engine 108 can communicate the low flow rate and the condition of the remote industrial equipment 504 that is within specification and an alert of the emergency event or a potential emergency event to the main control 410. In some examples, the emergency detection engine 108 can also communicate with a supervisor 412 (e.g., safety officer, building manager, etc.) to alert the supervisor 412 about the emergency event or the potential emergency event.

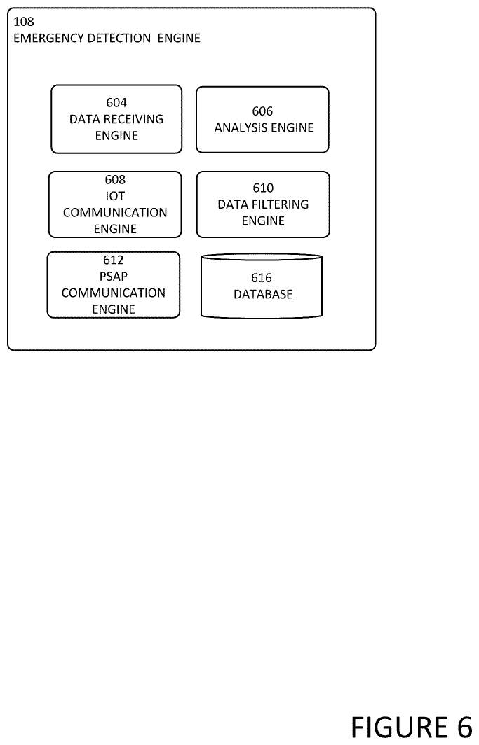

Turning to FIG. 6, FIG. 6 is a simplified block diagram illustrating example details of a particular non-limiting implementation of the emergency detection engine 108. The emergency detection engine 108 can include a data receiving engine 604, an analysis engine 606, an IoT communication engine 608, a data filtering engine 610, a PSAP communication engine 612, and a database 616.

The data receiving engine 604 receives data from IoT devices 116. The analysis engine 606 can analyze the received data from the IoT devices 116 to help detect an emergency event or a potential emergency event and aggregate data from two or more IoT devices 116 to help detect an emergency event or a potential emergency event. In some examples, the analysis engine 606 uses a computer model or machine learning to help detect an emergency event or a potential emergency event.

The IoT communication engine 608 can be configured to communicate with the IoT devices 116 and request data from the IoT devices 116. For example, if an IoT device 116 sends an alert or alarm (e.g., a smoke detector), the IoT communication engine 608 can be used to request data from other IoT devices 116 in the area to obtain additional details about the reason from the alert or alarm. The additional details can be used by the analysis engine 606 to determine if there is an emergency event or a potential emergency event.

The data filtering engine 610 can be configured to filter the data from the IoT devices 116 and determine the data or information that is relevant or will be helpful to a PSAP operator. For example, a PSAP operator may need to know how many occupants were in a vehicle during a crash, if they were wearing seatbelts, and if the air bags were deployed. The PSAP operator is unlikely to need to know the tire pressure of tires on the vehicle after the crash or the level of the windshield washing fluid. The PSAP communication engine 612 can communicate the relevant data from the IoT devices 116 to the PSAP for the data to be displayed on the PSAP display 112 for review by the PSAP operator. The database 616 can include available IoT devices that may be used by the emergency detection engine 108 to help detect an emergency event or a potential emergency event. In some examples, the data filtering engine 610 uses a computer model or machine learning to filter the data from the IoT devices 116 and determine the data or information that is relevant or will be helpful to a PSAP operator.

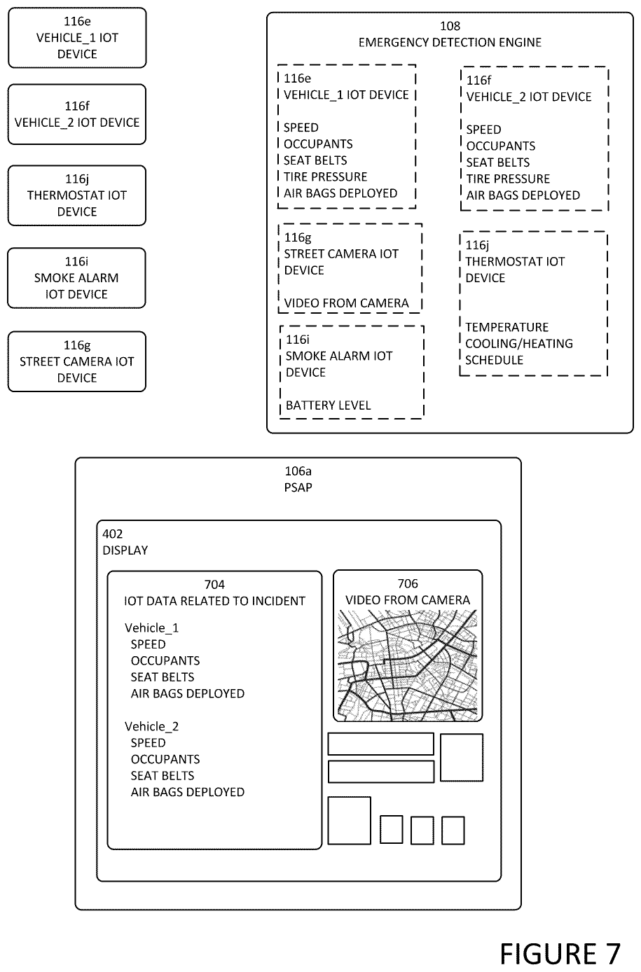

Turning to FIG. 7, FIG. 7 illustrates a specific example where a vehicle accident occurs similar to the vehicle accident event 206 illustrated in FIG. 2. For example, when the vehicle accident event 206 (not shown) occurs, the IoT device 116e located in the vehicle 204a (not shown) and can detect conditions related to the vehicle 204a before, during, and after the vehicle accident event 206 and the IoT device 116f located in vehicle 204b (not shown) and can detect conditions related to the vehicle 204b before, during, and after the vehicle accident event 206. The IoT device 116e can communicate with the emergency detection engine 108 and send data 702 related to the conditions related to the vehicle 204a before, during, and after the vehicle accident event 206. The IoT device 116f can also communicate with the emergency detection engine 108 and send data 704 related to the conditions related to the vehicle 204b before, during, and after the vehicle accident event 206. The emergency detection engine 108 can use the data 702 from the IoT device 116e and the data 704 from IoT device 116f and determine if the vehicle accident event 206 is an emergency event that requires attention from the PSAP 106a. If the emergency detection engine 108 determines the vehicle accident event 206 is an emergency event that requires attention from the PSAP 106, the emergency detection engine 108 can communicate relevant data 712 related to the vehicle accident event 206 to the PSAP 106a and the relevant data 712 can be displayed on the PSAP display 112 for the PSAP operator to use to determine the needed response.

In some examples, the emergency detection engine 108 can determine if any other IoT devices 116 are in the area of the vehicle accident event 206 to help the emergency detection engine 108 collect more details about the vehicle accident event 206. For example, the emergency detection engine 108 may determine that the IoT device 116g, a street camera, is available as well as the IoT device 116i, a smoke detector in a building near the vehicle accident event 206 and the IoT device 116j, a thermostat or room temperature gauge in the building near the vehicle accident event 206. Based on the data 708 from the IoT device 116i and the data 710 from the IoT device 1016j, the emergency detection engine 108 can be configured to determine that the IoT device 116i and the IoT device 1016j do not have any data relevant to the vehicle accident event 206. For example, the data 708 from the IoT device 116i, a smoke detector in a building near the vehicle accident event 206 may indicate there is no smoke in the building near the vehicle accident event 206 and the data 710 from the IoT device 116j, a thermostat or room temperature gauge in the building near the vehicle accident event 206 may indicate the temperature is within a normal or typical operating temperature range.

In some examples, the emergency detection engine 108 can use data 706 from the IoT device 116g to help determine if the vehicle accident event 206 is an emergency event that requires attention from the PSAP 106. In some examples, the emergency detection engine 108 can communicate the video feed from the IoT device 116g to the PSAP 106 to allow the human operator to have a live view of the vehicle accident event 206 to help the PSAP operator to use to determine the needed response. The PSAP display 112 can be a display that is viewed by a human operator at the PSAP 106. Note that that PSAP display 112 can display other information to the human operator at the PSAP 106, the information on the PSAP display 112 may be presented in a different way, and/or the information on the PSAP display 112 may be in a different layout.

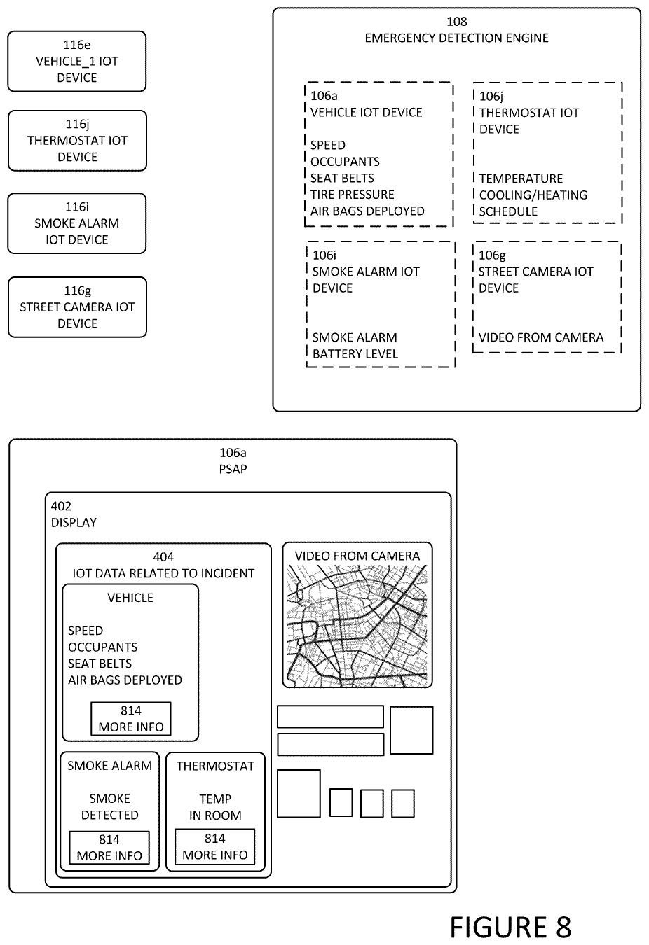

Turning to FIG. 8, FIG. 8 illustrates a specific example where a vehicle accident occurs similar to the single vehicle accident event 304 illustrated in FIG. 3. For example, when the single vehicle accident event 204 (not shown) occurs, the IoT device 116h located in the vehicle 204c (not shown) and can detect conditions related to the vehicle 204c before, during, and after the single vehicle accident event 304. The IoT device 116h can communicate with the emergency detection engine 108 and send the data 802 related to the conditions related to the vehicle 204c before, during, and after the single vehicle accident event 304. The emergency detection engine 108 can use the data 802 from the IoT device 116h and determine if the single vehicle accident event 304 is an emergency event that requires attention from the PSAP 106. If the emergency detection engine 108 determines the single vehicle accident event 304 is an emergency event that requires attention from the PSAP 106, the emergency detection engine 108 can communicate relevant data 812 related to the single vehicle accident event 304 to the PSAP 106 and the details can be displayed on the PSAP display 112 for the PSAP operator to use to determine the needed response.

In some examples, the emergency detection engine 108 can determine if any other IoT devices 116 are in the area of the single vehicle accident event 304 to help the emergency detection engine 108 collect more details about the single vehicle accident event 304. For example, the emergency detection engine 108 may determine that the IoT device 116g, a street camera, is available as well as the IoT device 116i, a smoke detector in a building near the single vehicle accident event 304 and the IoT device 116j, a thermostat or room temperature gauge in the building near the vehicle accident. Based on the data from the IoT device 116i and the IoT device 1016j, the emergency detection engine 108 can be configured to determine that the IoT device 116i and the IoT device 1016j have data that may be relevant to the single vehicle accident event 304. For example, the data from the IoT device 116i, a smoke detector in a building near the single vehicle accident event 304 may indicate there is smoke in the building near the single vehicle accident event 304 and the IoT device 116j, a thermostat or room temperature gauge in the building near the single vehicle accident event 304 may indicate the temperature is above a normal or typical operating temperature range and is rising.

In some examples, the emergency detection engine 108 can use data from the IoT device 116g to help determine if the single vehicle accident event 304 is an emergency event that requires attention from the PSAP 106. In some examples, the emergency detection engine 108 can communicate the video feed from the IoT device 116g to the PSAP 106 as part of the relevant data 812 related to the single vehicle accident event 304 to allow the human operator to have a live view of the single vehicle accident event 304 to help the PSAP operator determine the needed response. In addition, the emergency detection engine 108 can communicate the detection of smoke from the IoT device 116i and the abnormally increased temperature detected by the IoT device 106j as part of the relevant data 812 related to the single vehicle accident event 304 to the PSAP 106 to allow the human operator to decide if the emergency response will need to address a fire emergency and dispatch the appropriate response team. In some examples, for each IoT device 116, the human PSAP operator can be given a more info option 814. When the more info option 814 is selected, all the data from the IoT device 116 associated with the selected more info option 814 is displayed on the PSAP display 112 to be viewed by the human PSAP operator.

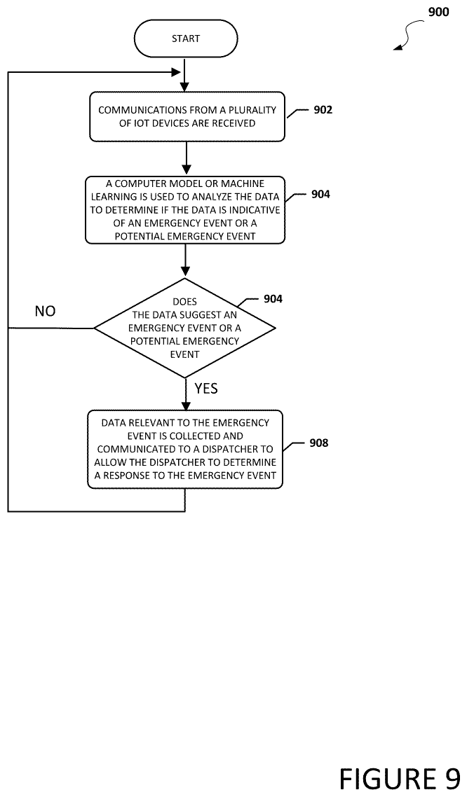

Turning to FIG. 9, FIG. 9 is example flowchart illustrating possible operations of a flow 900 that may be associated with potential operations to help enable aggregating data from IoT devices, in accordance with an embodiment of the present disclosure. Specifically, in some examples, one or more operations of flow 900 may be performed by the data receiving engine 604, the analysis engine 606, the IoT communication engine 608, the data filtering engine 610, and/or the PSAP communication engine 612. At 902, communications from a plurality of IoT devices are received. For example, the emergency detection engine 108 can receive data from a plurality of IoT devices 116. More specifically, the IoT device 116i, a smoke detector, may send a smoke detection signal to the emergency detection engine 108 and the IoT device 116j, a thermostat, in the area of the IoT device 116i may send an abnormally high room temperature reading (e.g., above 90 degrees) or some indication that the temperature in the room is rapidly climbing to the emergency detection engine 108. In another specific example, IoT device 116r, a remote machinery monitoring device, may send an out of specification warning (e.g., temperature out of specification, a rotating component is off balance and has out of specification wobbling, revolutions per minute are out of specification (either too low or too high), etc.) to the emergency detection engine 108 and IoT device 116s, a flow rate meter, may send a flow rate warning to the emergency detection engine 108.

At 904, a computer model or machine learning is used to analyze the data to determine if the data is indicative of an emergency event or a potential emergency event. For example, using the smoke detection signal from the IoT device 116i and the abnormally high room temperature reading (e.g., above 90 degrees) or some indication that the temperature in the room is rapidly climbing from the IoT device 116j, the emergency detection engine 108 can determine that a fire may be occurring or a potential fire may occur. In another example, using the out of specification warning from the IoT device 116r and the flow rate warning from IoT device 116s, the emergency detection engine 108 can determine there is a fault with remote equipment that is causing an emergency event or may cause an emergency event.

At 904, the system determines if the data suggests an emergency event or a potential emergency event. If the data does suggest an emergency event or a potential emergency event, data relevant to the emergency event is collected and communicated to a dispatcher to allow the dispatcher to determine a response to the emergency event. For example, the emergency detection engine 108 can communicate the smoke detection signal from the IoT device 116i and abnormally high room temperature reading (e.g., above 90 degrees) or some indication that the temperature in the room is rapidly climbing from the IoT device 116j to a PSAP to allow a PSAP operator to dispatch fire emergency response to the location of the IoT device 116i and the IoT device 116j. In another example, the emergency detection engine 108 can communicate the out of specification warning from the IoT device 116r and the flow rate warning from IoT device 116s to a control station and/or a safety supervisor where an operator at the control station or the safety supervisor may shutdown remote equipment associated with the IoT device 116r and the IoT device 116s and/or may dispatch a repair technician to the remote equipment.

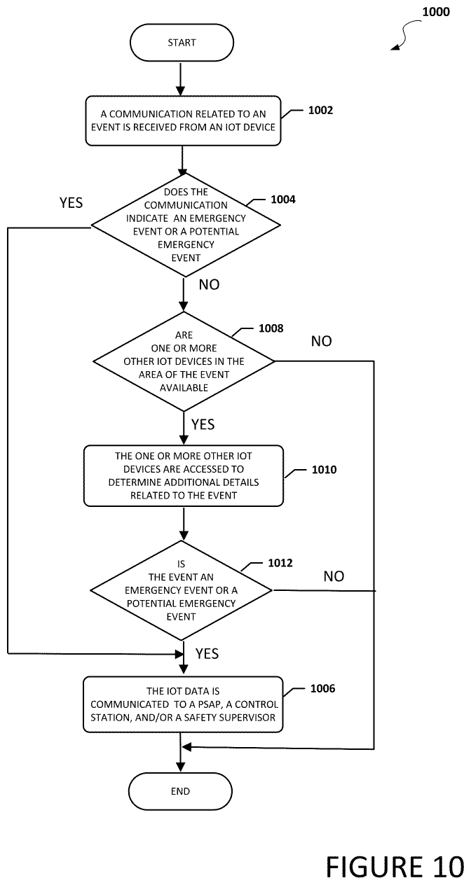

Turning to FIG. 10, FIG. 10 is example flowchart illustrating possible operations of a flow 1000 that may be associated with potential operations to help enable aggregating data from IoT devices, in accordance with an embodiment of the present disclosure. Specifically, in some examples, one or more operations of flow 1000 may be performed by the data receiving engine 604, the analysis engine 606, the IoT communication engine 608, the data filtering engine 610, and/or the PSAP communication engine 612. At 1002, a communication related to an event is received from an IoT device. For example, a communication from an IoT device 116 can be received by the PSAP 106. At 1104, the system determines if the communication indicates an emergency event or a potential emergency event. For example, the communication from the IoT device 116 may be a smoke detection alarm, related to a vehicle crash, etc.

If the communication indicates an emergency event or a potential emergency event, the IoT data is communicated to a PSAP a control station, and/or a safety supervisor, as in 1006. For example, IoT data related to a vehicle crash may indicate that the vehicle crash was a high-speed vehicle crash that is likely to be an emergency event and the IoT data can be communicated to a PSAP. If the IoT data is from one or more industrial IoT devices, the data can be communicated to a control station and/or a safety supervisor. If the communication does not indicate an emergency event or a potential emergency event, the system determines if one or more other IoT devices in the area of the event are available, as in 1008. For example, data related to a vehicle crash may indicate that the vehicle crash was a low-speed vehicle crash that is unlikely to cause any injuries to the occupant(s) of the vehicle and therefore is unlikely to be an emergency event or a potential emergency event. By determining if one or more other IoT devices in the area of the event are available, the system can obtain additional details about the event to help determine if the event is an emergency event or a potential emergency event.

If one or more other IoT devices in the area of the event are available, the one or more other IoT devices are accessed to determine additional details related to the event, as in 1010. For example, a street camera, security camera, or other type of video camera may be available in the area of the event. The feed from the street camera, security camera, or other type of video camera can help provide additional details about the event to help determine if the event is an emergency event or a potential emergency event.

At 1012, the system determines if, based on the additional data, the event is an emergency event or a potential emergency event. For example, based on the feed from the street camera, security camera, or other type of video camera, the low-speed single car crash may have knocked over a light pole where live electrical wires are on the ground and could cause an emergency event. If, based on the additional data, the system determines the event is an emergency event or a potential emergency event, the IoT data is communicated to a PSAP, a control station, and/or a safety supervisor, as in 1006. For example, the data related to the low-speed vehicle crash and the feed from the street camera, security camera, or other type of video camera showing the low-speed single car crash knocked over a light pole where live electrical wires are on the ground can be communicated to the PSAP. If, based on the additional data, the system determines the event is not an emergency event or a potential emergency event, the IoT data is not communicated to a PSAP, a control station, and/or a safety supervisor.

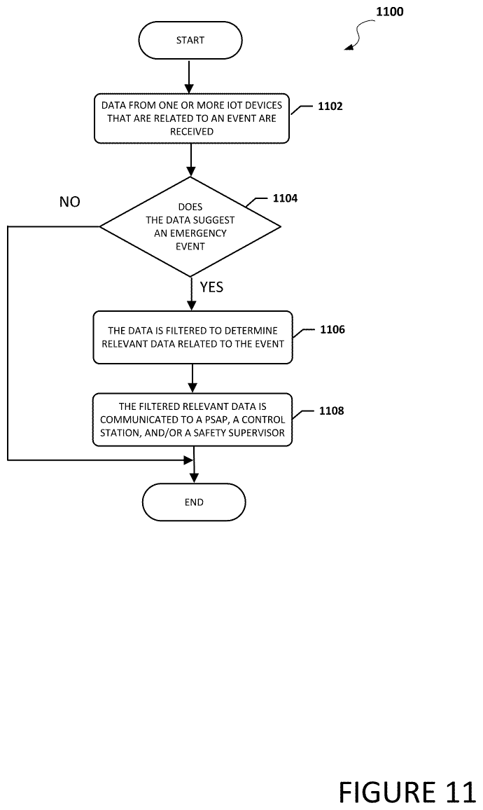

Turning to FIG. 11, FIG. 11 is example flowchart illustrating possible operations of a flow 1100 that may be associated with potential operations to help enable aggregating data from IoT devices, in accordance with an embodiment of the present disclosure. Specifically, in some examples, one or more operations of flow 1100 may be performed by the data receiving engine 604, the analysis engine 606, the IoT communication engine 608, the data filtering engine 610, and/or the PSAP communication engine 612. At 1102, data from one or more IoT devices that are related to an event are received. For example, data related to a vehicle crash from a first vehicle IoT device and from a second IoT device may be received or data from the first vehicle IoT device, the second vehicle IoT device, and a street or security camera may be received. In another example, data related to a potential fire from a smoke detector IoT device and from a thermostat IoT device may be received. In yet another example, data related to a potential machinery malfunction from a first IoT device and a second IoT device may be received.

At 1104, the system determines if the data suggests an emergency event. For example, the data related to a vehicle crash from the first vehicle IoT device and from the second IoT device can indicate a high-speed crash that is likely to cause one or more severe or critical injuries or a very low-speed fender bump that is likely to cause very minor if any injuries. In another example, data from the smoke detector IoT device may indicate the presence of smoke and data from the thermostat IoT device may indicate the temperature in a room rapidly rising indicating a fire or data from the smoke detector IoT device may indicate the presence of smoke and data from the thermostat IoT device may indicate the temperature in a room is normal and that the presence of smoke may be from overcook food. In yet another example, the data related to a potential machinery malfunction from the first IoT device and the second IoT device may indicate one or more machines may be on the brink of a major failure or the data related to a potential machinery malfunction from the first IoT device and the second IoT device may indicate one or more machines may need minor maintenance. If the system determines the data does not suggest an emergency event, the process ends. If the system determines the data suggest an emergency event, the data is filtered to determine relevant data related to the event. For example, the relevant data related to the vehicle crash from the first vehicle IoT device and from the second IoT device can include the speed of the vehicles, number of occupants in each vehicle, whether or not the occupants were wearing seatbelts, etc. Data related to the vehicle crash from the first vehicle IoT device and from the second IoT device that is not relevant to the vehicle crash can include the tire pressure of each tire of the vehicles, the oil life expectancy for the motor oil in each vehicle, whether or not the radio was on in each vehicle, etc. In another example, relevant data related to a potential fire from the smoke detector IoT device can include the time the smoke was detected and the location of the smoke detector IoT device and data from the thermostat IoT device can include how quickly the temperature in a room is rising and the location of the thermostat IoT device. Data related to the potential fire from the smoke detector IoT device and from the thermostat IoT device that is not relevant to the potential fire can include a battery level of each device, the user configured display or home screen of the thermostat IoT device, etc. In yet another example, relevant data related to potential machinery malfunction from the first IoT device and the second IoT device can include an excessive high temperature reading or revolutions per minute reading, an indication that one or more conditions or the machinery is out of specification, etc. Data related to the potential machinery malfunction from the first IoT device and the second IoT device that is not relevant to the emergency event can include a battery level or power level of each of the first IoT device and the second IoT device, the version of firmware installed on each of the first IoT device and the second IoT device, etc. At 1108, the filtered relevant data is communicated to a PSAP, a control station, and/or a safety supervisor.

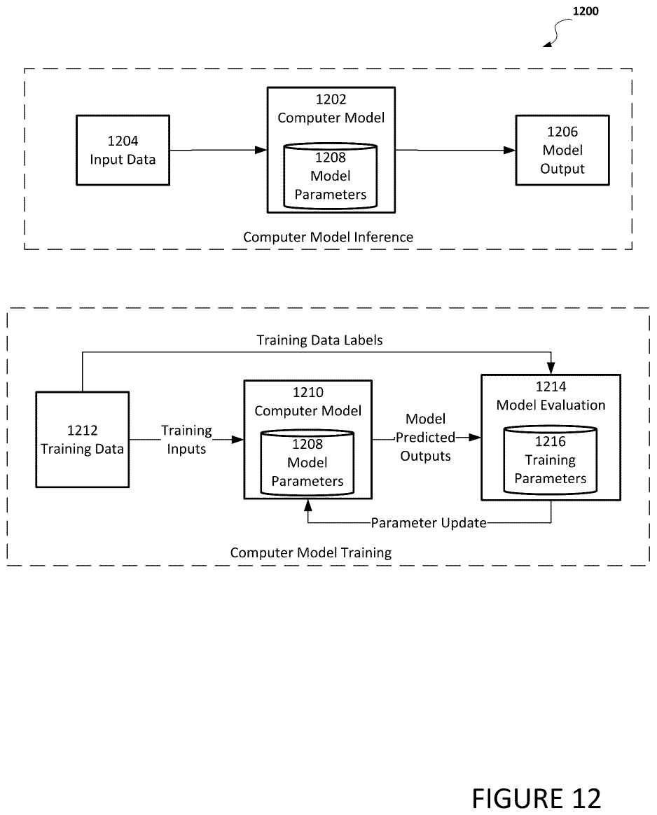

Turning to FIG. 12, FIG. 12 illustrates example computer model inference and computer model training 1200. Computer model inference refers to the application of a computer model 1202 to a set of input data 1204 to generate an output or model output 1206. The computer model 1202 determines the model output 1206 based on parameters of the model, also referred to as model parameters 1208. The parameters of the model may be determined based on a training process that finds an optimization of the model parameters 1208, typically using training data and desired outputs of the model for the respective training data as discussed below. The output (e.g., if IoT data is indicative of an emergency event or a potential emergency event) of the computer model 1202 may be referred to as an “inference” because it is a predictive value based on the input data 1204 and based on previous example data used in the model training.

The input data 1204 and the model output 1206 vary according to the particular use case. For example, to determine if IoT data is indicative of an emergency event or a potential emergency event, the input data 1204 may be data from one or more IoT devices and the output or “inference” may be a score or some other indication of the likelihood the IoT data is indicative of an emergency event or a potential emergency event. In an illustrative example of classifications of portions of an image, computer vision and image analysis, the input data 1204 may be an image having a particular resolution, such as 75×75 pixels, or a point cloud describing a volume. In other applications, the input data 1204 may include a vector, such as a sparse vector, representing information about an object. For example, in recommendation systems, such a vector may represent user-object interactions, such that the sparse vector indicates individual items positively rated by a user. In addition, the input data 1204 may be a processed version of another type of input object, for example representing various features of the input object or representing preprocessing of the input object before input of the object to the computer model 1202. As one example, a 1024×1024 resolution image may be processed and subdivided into individual image portions of 64×64, which are the input data 1204 processed by the computer model 1202. As another example, the input object, such as a sparse vector discussed above, may be processed to determine an embedding or another compact representation of the input object that may be used to represent the object as the input data 1204 in the computer model 1202. Such additional processing for input objects may themselves be learned representations of data, such that another computer model processes the input objects to generate an output that is used as the input data 1204 for the computer model 1202. Although not further discussed here, such further computer models may be independently or jointly trained with the computer model 1202. As noted above, the model output 1206 may depend on the particular application of the computer model 1202, for example, aggregating data from IoT devices.

The computer model 1202 includes various model parameters 1208, as noted above, that describe the characteristics and functions that generate the model output 1206 from the input data 1204. In particular, the model parameters 1208 may include a model structure, model weights, and a model execution environment. The model structure may include, for example, the particular type of computer model 1202 and its structure and organization. For example, the model structure may designate a neural network, which may be comprised of multiple layers, and the model parameters 1208 may describe individual types of layers included in the neural network and the connections between layers (e.g., the output of which layers constitute inputs to which other layers). Such networks may include, for example, feature extraction layers, convolutional layers, pooling/dimensional reduction layers, activation layers, output/predictive layers, and so forth. While in some instances the model structure may be determined by a designer of the computer model, in other examples, the model structure itself may be learned via a training process and may thus form certain “model parameters” of the model.

The model weights may represent the values with which the computer model 1202 processes the input data 1204 to the model output 1206. Each portion or layer of the computer model 1202 may have such weights. For example, weights may be used to determine values for processing inputs to determine outputs at a particular portion of a model. Stated another way, for example, model weights may describe how to combine or manipulate values of the input data 1204 or thresholds for determining activations as output for a model. As one example, a convolutional layer typically includes a set of convolutional “weights,” also termed a convolutional kernel, to be applied to a set of inputs to that layer. These are subsequently combined, typically along with a “bias” parameter, and weights for other transformations to generate an output for the convolutional layer.

The model execution parameters represent parameters describing the execution conditions for the model. In particular, aspects of the model may be implemented on various types of hardware or circuitry for executing the computer model 1202. For example, portions of the model may be implemented in various types of circuitry, such as general-purpose circuity (e.g., a general CPU), circuity specialized for certain functions (e.g., a GPU or programmable Multiply-and-Accumulate circuit) or circuitry specially designed for the particular computer model application. In some configurations, different portions of the computer model 1202 may be implemented on different types of circuitries. As discussed below, training of the model may include optimizing the types of hardware used for certain aspects of the computer model 1202 (e.g., co-trained), or may be determined after other parameters for the computer model 1202 are determined without regard to configuration executing the model. In another example, the execution parameters may also determine or limit the types of processes or functions available at different portions of the model, such as value ranges available at certain points in the processes, operations available for performing a task, and so forth.

Computer model training may thus be used to determine or “train” the values of the model parameters 1208 for the computer model 1210. During training, the model parameters 1208 are optimized to “learn” values of the model parameters (such as individual weights, activation values, model execution environment, etc.), that improve the model parameters 1208 based on an optimization function that seeks to improve a cost function (also sometimes termed a loss function). Before training, the computer model 1210 has model parameters 1208 that have initial values that may be selected in various ways, such as by a randomized initialization, initial values selected based on other or similar computer models, or by other means. During training, the model parameters are modified based on the optimization function to improve the cost/loss function relative to the prior model parameters.

In many applications, training data 1212 includes a data set to be used for training the computer model 1210. The data set varies according to the particular application and purpose of the computer model 1210. In supervised learning tasks, the training data 1212 typically includes a set of training data labels that describe the training data 1212 and the desired output of the model relative to the training data 1212. For example, for an emergency event or a potential emergency event recognition task, the training data 1212 may include IoT data collected during an emergency event and labeled with the classification of the emergency event. For this task, the training data 1212 may include IoT training data related to the emergency event, such that the computer model 1210 is intended to learn to also label the same type of IoT data as being related to an emergency event.

To train the computer model 1210, a training module (not shown) applies the training inputs to the computer model 1210 to determine the outputs predicted by the model for the given training inputs. The training module, though not shown, is a computing module used for performing the training of the computer model 1210 by executing the computer model 1210 according to its inputs and outputs given the model's parameters and modifying the model parameters based on the results. The training module may apply the actual execution environment of the computer model 1210, or may simulate the results of the execution environment, for example to estimate the performance, runtime, memory, or circuit area (e.g., if specialized hardware is used) of the computer model 1210. The training module, along with the training data 1212 and model evaluation, may be instantiated in software and/or hardware by one or more processing devices. In various examples, the training process may also be performed by multiple computing systems in conjunction with one another, such as distributed/cloud computing systems. In some examples the training of the computer module 1210 may be different if the computer model 1210 is a large language model (LLM) used for automated message responses as compared to being used to determine if IoT data is indicative of an emergency event or a potential emergency event. A LLM is used for language-based tasks, whereas the general AI model or computer model can be used for a variety of other tasks, including to determine if IoT data is indicative of an emergency event or a potential emergency event.

After processing the training inputs according to the current model parameters for the computer model 1210, the model's predicted outputs are evaluated and the computer model 1210 is evaluated with respect to the cost function and optimized using an optimization function of the training model. Depending on the optimization function, particular training process and training parameters 1216 after the model evaluation are updated to improve the optimization function of the computer model 1210. In supervised training (i.e., training data labels are available), the cost function may evaluate the model's predicted outputs relative to the training data labels and to evaluate the relative cost or loss of the prediction relative to the “known” labels for the data. This provides a measure of the frequency of correct predictions by the computer model 1210 and may be measured in various ways, such as the precision (frequency of false positives) and recall (frequency of false negatives). The cost function in some circumstances may also evaluate other characteristics of the model, for example the model complexity, processing speed, memory requirements, physical circuit characteristics (e.g., power requirements, circuit throughput) and other characteristics of the computer model 1210 structure and execution environment (e.g., to evaluate or modify these model parameters).

After determining results of the cost function, the optimization function determines a modification of the model parameters to improve the cost function for the training data 1212. Many such optimization functions are known to one skilled on the art. Many such approaches differentiate the cost function with respect to the parameters of the model and determine modifications to the model parameters that thus improves the cost function. The parameters for the optimization function, including algorithms for modifying the model parameters are the training parameters 1216 for the optimization function. For example, the optimization algorithm may use gradient descent (or its variants), momentum-based optimization, or other optimization approaches used in the art and as appropriate for the particular use of the model. The optimization algorithm thus determines the parameter updates to the model parameters. In some implementations, the training data 1212 is batched and the parameter updates are iteratively applied to batches of the training data 1212. For example, the model parameters may be initialized, then applied to a first batch of data to determine a first modification to the model parameters. The second batch of data may then be evaluated with the modified model parameters to determine a second modification to the model parameters, and so forth, until a stopping point, typically based on either the amount of training data 1212 available or the incremental improvements in model parameters are below a threshold (e.g., additional training data 1212 no longer continues to improve the model parameters). Additional training parameters 1216 may describe the batch size for the training data 1212, a portion of training data 1212 to use as validation data, the step size of parameter updates, a learning rate of the model, and so forth. Additional techniques may also be used to determine global optimums or address nondifferentiable model parameter spaces.

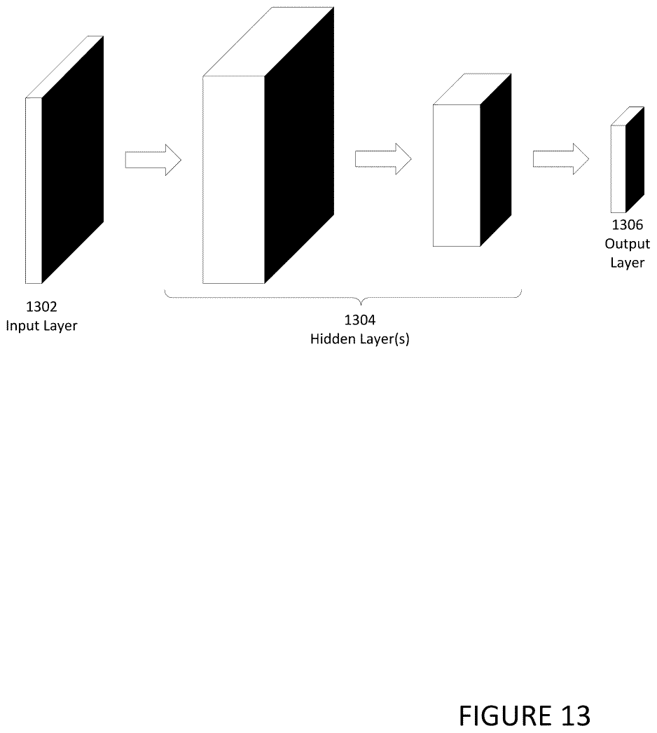

Turning to FIG. 13, FIG. 13 illustrates an example neural network architecture. In general, a neural network includes an input layer 1302, one or more hidden layers 1304, and an output layer 1306. The values for data in each layer of the network is generally determined based on one or more prior layers of the network. Each layer of a network generates a set of values, termed “activations” that represent the output values of that layer of a network and may be the input to the next layer of the network. For the input layer 1302, the activations are typically the values of the input data, although the input layer 1302 may represent input data as modified through one or more transformations to generate representations of the input data. For example, in recommendation systems, interactions between users and objects may be represented as a sparse matrix. Individual users or objects may then be represented as an input layer 1302 as a transformation of the data in the sparse matrix relevant to that user or object. The neural network may also receive the output of another computer model (or several), as its input layer 1302, such that the input layer 1302 of the neural network shown in FIG. 13 is the output of another computer model. Accordingly, each layer may receive a set of inputs, also termed “input activations,” representing activations of one or more prior layers of the network and generate a set of outputs, also termed “output activations” representing the activation of that layer of the network. Stated another way, one layer's output activations become the input activations of another layer of the network, except for the final output layer of 1306 of the network.

Each layer of the neural network typically represents its output activations (i.e., also termed its outputs) in a matrix, which may be 1, 2, 3, or n-dimensional according to the particular structure of the network. As shown in FIG. 13, the dimensionality of each layer may differ according to the design of each layer. The dimensionality of the output layer 1306 depends on the characteristics of the prediction made by the model. For example, a computer model for multi-object classification may generate an output layer 1306 having a one-dimensional array in which each position in the array represents the likelihood of a different classification for the input layer 1302. In another example for classification of portions of an image, the input layer 1302 may be an image having a resolution, such as 512×512, and the output layer may be a 512×512×n matrix in which the output layer 1306 provides n classification predictions for each of the input pixels, such that the corresponding position of each pixel in the input layer 1302 in the output layer 1306 is an n-dimensional array corresponding to the classification predictions for that pixel.

The hidden layers 1304 provide output activations that variously characterize the input layer 1302 in various ways that assist in effectively generating the output layer 1306. The hidden layers thus may be considered to provide additional features or characteristics of the input layer 1302. Though two hidden layers are shown in FIG. 13, in practice any number of hidden layers may be provided in various neural network structures.

Each layer generally determines the output activation values of positions in its activation matrix based on the output activations of one or more previous layers of the neural network (which may be considered input activations to the layer being evaluated). Each layer applies a function to the input activations to generate its activations. Such layers may include fully-connected layers (e.g., every input is connected to every output of a layer), convolutional layers, deconvolutional layers, pooling layers, and recurrent layers. Various types of functions may be applied by a layer, including linear combinations, convolutional kernels, activation functions, pooling, and so forth. The parameters of a layer's function are used to determine output activations for a layer from the layer's activation inputs and are typically modified during the model training process. The parameters describing the contribution of a particular portion of a prior layer is typically termed a weight. For example, in some layers, the function is a multiplication of each input with a respective weight to determine the activations for that layer. For a neural network, the parameters for the model as a whole thus may include the parameters for each of the individual layers and in large-scale networks can include hundreds of thousands, millions, or more of different parameters.

As one example for training a neural network, the cost function is evaluated at the output layer 1306. To determine modifications of the parameters for each layer, the parameters of each prior layer may be evaluated to determine respective modifications. In one example, the cost function (or “error”) is backpropagated such that the parameters are evaluated by the optimization algorithm for each layer in sequence, until the input layer 1302 is reached.

In the description, various aspects of the illustrative implementations are described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials, and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

In the detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. Reference to “one example” or “an example” in the present disclosure means that a particular feature, structure, or characteristic described in connection with the embodiment is included in at least one example or embodiment. The appearances of the phrase “in one example” or “in an example” are not necessarily all referring to the same examples or embodiments. The terms “substantially,” “close,” “approximately,” “near,” and “about,” generally refer to being within +/−20% of a target value based on the context of a particular value as described herein or as known in the art.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur. Substantial flexibility is provided by the system, apparatus, and a method to enable aggregating data from IoT devices in that any suitable arrangements, chronologies, configurations, and timing mechanisms may be provided without departing from the teachings of the present disclosure.

Note that embodiments of the PSAP 106, emergency detection engine 108, IoT devices 116, server 120, cloud services 122, and network element 124, may include one or more distinct interfaces, represented by any suitable network interfaces to facilitate communication via the various networks (including both internal and external networks) described herein. Such network interfaces may be inclusive of multiple wired and/or wireless interfaces (e.g., Wi-Fi, WiMax, 3G, 4G, 5G+, white space, 802.11x, satellite, Bluetooth, LTE, GSM/HSPA, CDMA/EVDO, DSRC, CAN, GPS, etc.). Other interfaces, may include physical ports (e.g., Ethernet, USB, HDMI, etc.), interfaces for wired and wireless internal subsystems, and the like. Similarly, each of the PSAP 106, emergency detection engine 108, IoT devices 116, server 120, cloud services 122, and network element 124 can also include suitable interfaces for receiving, transmitting, and/or otherwise communicating data or information in a network environment.

The PSAP 106, emergency detection engine 108, IoT devices 116, server 120, cloud services 122, and network element 124 and other associated or integrated components can include one or more memory elements for storing information to be used in achieving operations associated with aggregating data from IoT devices, as outlined herein. These devices may further keep information in any suitable memory element (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in the system 100 could be provided in any database, register, table, cache, queue, control list, or storage structure, based on particular needs and implementations, all of which could be referenced in any suitable timeframe. Any of the memory or storage options discussed herein should be construed as being encompassed within the broad term ‘memory element’ as used herein in this Specification.

In example embodiments, the operations for enabling aggregating data from IoT devices, outlined herein, may be implemented by logic encoded in one or more tangible media, which may be inclusive of non-transitory media (e.g., embedded logic provided in an ASIC, digital signal processor (DSP) instructions, software potentially inclusive of object code and source code to be executed by a processor or other similar machine, etc.). In some of these instances, one or more memory elements can store data used for the operations described herein. This includes the memory elements being able to store software, logic, code, or processor instructions that are executed to carry out the aggregating data from IoT devices described in this Specification. Regarding a physical implementation of the data receiving engine 604, the analysis engine 606, the IoT communication engine 608, the data filtering engine 610, and/or the PSAP communication engine 612 and their associated components, any suitable permutation may be applied based on particular needs and requirements.

Note that with the examples provided herein, interaction may be described in terms of one, two, three, or more elements. However, this has been done for purposes of clarity and example only. In certain cases, it may be easier to describe one or more of the functionalities by only referencing a limited number of elements. It should be appreciated that the system, apparatus, and a method to enable aggregating data from IoT devices and their teachings are readily scalable and can accommodate a large number of components, as well as more complicated/sophisticated arrangements and configurations. Accordingly, the examples provided should not limit the scope or inhibit the broad teachings of the system, apparatus, and method to enable aggregating data from IoT devices and as potentially applied to a myriad of other architectures.

It is also important to note that the operations in the preceding flow diagrams (i.e., FIGS. 9-11) illustrate only some of the possible correlating scenarios and patterns that may be executed, some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although the system and method have been illustrated with reference to particular elements and operations, these elements and operations may be replaced by any suitable architecture, protocols, and/or processes that achieve the intended functionality of the system and method.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
determining an emergency event is occurring;
identifying one or more IoT devices in an area of the emergency event;
notifying an emergency service personnel of the one or more IoT devices in the area of the emergency event;
allowing the emergency service personnel to access at least one of the one or more IoT devices; and
communicating real-time data from the at least one of the one or more IoT devices to the emergency service personnel.

2. The method of claim 1, wherein a computer model or machine learning is used to determination an emergency event is occurring.

3. The method of claim 1, wherein the data from the at least one of the one or more IoT devices is displayed on a screen for viewing by the emergency service personnel.

4. The method of claim 1, wherein at least two IoT devices are in the area of the emergency event and the data from the at least two IoT devices is displayed on a screen for viewing by the emergency service personnel.

5. The method of claim 1, wherein data from a specific IoT device does not indicate the emergency event, however, when the data from the specific IoT device is combined with data from one or more other IoT devices, the data from the specific IoT device and the data from the one or more other IoT devices indicates the emergency event.

6. The method of claim 1, wherein at least one of the one or more IoT devices is a camera.

7. The method of claim 1, wherein at least two of the one or more IoT devices are different types of IoT devices.

8. A system, comprising:
memory;
at least one processor;
an emergency detection engine configured to:
determine an emergency event is occurring;
identify one or more IoT devices in an area of the emergency event;
notify an emergency service personnel of the one or more IoT devices in the area of the emergency event;
allow the emergency service personnel to access at least one of the one or more IoT devices; and
communicate real-time data from the at least one of the one or more IoT devices to the emergency service personnel.

9. The system of claim 8, wherein at least two IoT devices are in the area of the emergency event and the data from the at least two IoT devices is displayed on a screen for viewing by the emergency service personnel.

10. The system of claim 8, wherein the emergency detection engine uses a computer model or machine learning to determine that the data from the one or more IoT devices indicates the emergency event.

11. The system of claim 8, wherein the emergency detection engine uses a computer model or machine learning to filter the data from the one or more IoT devices to create relevant data for the emergency event.

12. The system of claim 8, wherein data from a specific IoT device does not indicate the emergency event, however, when the data from the specific IoT device is combined with data from one or more other IoT devices, the data from the specific IoT device and the data from the one or more other IoT devices indicates the emergency event.

13. The system of claim 8, wherein at least one of the one or more IoT devices is a video camera.

14. The system of claim 8, wherein at least a majority of the one or more IoT devices are different types of IoT devices.

15. A method, comprising:
receiving data, from an Internet of Things (IoT) device, related to an event;
determining one or more IoT devices are in an area of the event;
notifying an emergency service personnel of the one or more IoT devices in the area of the event;
receiving a request, from the emergency service personnel, for data from the one or more IoT devices in the area of the event; and
allowing the emergency service personnel to access the data from the one or more IoT devices in the area of the event; and
communicating real-time data from the one or more IoT devices in the area of the event to the emergency service personnel.

16. The method of claim 15, further comprising:
using the received data from the IoT device related to the event to determination an emergency event is occurring.

17. The method of claim 15, wherein a computer model or machine learning is used to determination an emergency event is occurring.

18. The method of claim 17, further comprising:
filtering the data from the IoT device and the data from the one or more IoT devices in the area of the event to create relevant data for the event; and
communicating the relevant data for the event to a public safety answering point (PSAP) or a control center.

19. The method of claim 15, wherein the data is filtered using a computer model or machine learning.

20. The method of claim 15, wherein the IoT device is a video camera.
